(19) United States
(12) Patent Application Publication
(10) Pub. No.: US 2008/0165944 A1
(43) Pub. Date: Jul. 10, 2008

(54) CONFERENCE CALLING SERVICES

(75) Inventors: Lawrence Rosenthal, Berkeley, CA (US); Robert Carr, Foster City, CA (US); Mark Dzwonczyk, Mountain View, CA (US)

Correspondence Address: BEYER WEAVER LLP, P.O. BOX 70250, OAKLAND, CA, 94612-0250, US

(73) Assignee: T-TAG CORPORATION, San Francisco, CA (US)

(21) Appl. No.: 11/854,347

(22) Filed: Sep. 12, 2007

Related U.S. Application Data
(60) Provisional application No. 60/825,376, filed on Sep. 12, 2006.

(51) Int. Cl. H04M 3/42

(52) U.S. Cl. 379/202.01

(57) ABSTRACT

Methods and apparatus are described for initiating a conference call having a plurality of participants. A call originator is enabled to identify one or more participant identifiers. The call originator is enabled to establish a first connection to a remote system by which the one or more participant identifiers are communicated to the remote system. Establishment of the first connection does not require administrative access to the remote system. A second connection is established from the remote system to each of one or more voice communication devices corresponding to one or more of the participants using the one or more participant identifiers.

### RELATED APPLICATION DATA

The present application claims priority under 35 U.S.C. 119(e) to U.S. Provisional Patent Application No. 60/825,376 filed Sep. 12, 2006 (Attorney Docket No. TTAGP003P), the entire disclosure of which is incorporated herein by reference for all purposes.

### BACKGROUND OF THE INVENTION

The present invention relates to techniques for facilitating conference calls.

A conventional conferencing system typically employs a back-end conference bridge to mix the audio from multiple telephone calls into a virtual conference “room” in which all of the participants can speak and listen to all of the other participants. In these conventional approaches, each of the participants calls into a particular number and enters an access code to enter the conference room. Providers of such conventional conferencing systems include, for example, Avaya Inc. of Basking Ridge, N.J., Compunetix Inc. of Monroeville, Pa., Multi-Link of Denver, Colo., and Polycom Inc. of Pleasanton, Calif. Some conference bridges have the ability to call out to a static list of participants. However, the list must be pre-programmed by an administrator having administrative access to the bridge, and the conference must first be initiated in a conventional manner by at least one of the participants dialing into the server and entering the access code before selecting or otherwise identifying the static list to be called.

### SUMMARY OF THE INVENTION

According to the present invention, a variety of conferencing services are enabled. According to one class of embodiments, methods and apparatus are provided for initiating a conference call having a plurality of participants. A call originator is enabled to identify one or more participant identifiers. The call originator is enabled to establish a first connection to a remote system by which the one or more participant identifiers are communicated to the remote system. Establishment of the first connection does not require administrative access to the remote system. A second connection is established from the remote system to each of one or more voice communication devices corresponding to one or more of the participants using the one or more participant identifiers.

According to another class of embodiments, a voice communication device is provided having a user interface controlled by first logic configured to enable a call originator to identify one or more participant identifiers. Each of the participant identifiers corresponds to an additional voice communication device and enables connection to the additional voice communication device. The user interface is further controlled by second logic configured to enable the call originator to initiate establishment of a connection to a remote system by which the one or more participant identifiers are communicated to the remote system, thereby enabling the remote system to initiate a conference call including the voice communication device and the one or more additional voice communication devices. Establishment of the connection does not require administrative access to the remote system.

According to yet another class of embodiments, methods and apparatus are provided for facilitating a conference call having a plurality of participants. A plurality of participant identifiers associated with the conference call are stored. A first connection request is received from a first voice communication device having a first identifier associated therewith for facilitating connection to the first voice communication device. The first voice communication device is automatically connected to the conference call without requiring further authentication where the first identifier is included among the plurality of participant identifiers.

A further understanding of the nature and advantages of the present invention may be realized by reference to the remaining portions of the specification and the drawings.

### BRIEF DESCRIPTION OF THE DRAWINGS

FIGS. 1A-1D include screen shots illustrating various aspect of the present invention.

FIGS. 2A-2C include screen shots illustrating further aspects of the present invention.

FIG. 3 is a flowchart illustrating operation of a specific embodiment of the invention.

FIG. 4 includes a screen shot illustrating yet another aspect of the present invention.

FIG. 5A-5H include screen shots illustrating still further aspects of the present invention.

FIG. 6 is a simplified block diagram illustrating a network environment in which various embodiments of the invention may be implemented.

FIG. 7 is a functional block diagram of an example implementation of a specific embodiment of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention. It should also be noted that the order in which process operations are described in the specification or recited in the claims of the present application should not be construed as limiting the scope of the invention to the order described or recited.

Embodiments of the present invention enable a new class of voice communication service which allows a conference call originator using virtually any type of telephone or voice communication device or client which employs numbers or equivalent identifiers to connect with other parties, to queue up as many numbers as the conference call originator likes (e.g., one or more), and establish a conference call with all of the parties. Unlike previous call-out solutions which require that an administrator log in to enter a set of phone numbers, embodiments of the present invention enable any end user to create an ad hoc set of participants and initiate or schedule a conference for those participants.

According to various specific embodiments, a queue or list of identifiers may be queued up by selecting preexisting entries, e.g., from contacts lists or address books, by manually entering the identifiers, e.g., using a keypad, or a combination of both. As will be understood, the terms “list” and “queue” are not used in a limiting manner and include any grouping of such identifiers.

Embodiments will be described herein which refer to the devices associated with the participants of a conference call as “phones.” It should be noted at the outset that this term is used for convenience, and that virtually any type of voice communication device which employs participant identifiers, contact numbers, or the equivalent, to effect connections with other communication devices may be employed without departing from the scope of the invention. For example, in addition to cellular phones and land line phones, the present invention may be used with IP phones, VoIP devices, or any type of telephony device, client, or application which enables voice communication using participant or contact identifiers associated with other devices.

And generally speaking, the queuing mechanisms and conference calling functionalities of the present invention can be implemented using any interface of any device which can be used for voice communication over any of a wide variety of media including, for example, the PSTN, cellular networks, the Internet, or any combination of these. It should be noted, therefore, that references below to specific mechanisms are used merely for simplicity and should not be used to limit the scope of the invention.

According to a particular class of embodiments, a layer of functionality is provided relative to a conventional back-end conference bridge which allows a list of participant identifiers, e.g., phone numbers, to be dynamically created, and then automatically called and inserted into a conference without having to manually initiate the conference. According to this class of embodiments, a back-end process (also referred to herein as “the Vello process” and/or the “Vello server(s)”) works in conjunction with a conventional conference bridge to replace the manual approach with which participants conventionally connect to conferences with an automated approach in which the system calls out to each participant in a list or queue including, in some cases, the originator of the conference.

As mentioned above, embodiments of the present invention enable any end user to set up a conference call in an ad hoc manner. According to various embodiments, there are a number of ways in which the list or queue of participant identifiers, e.g., phone numbers, may be generated and/or communicated to the system. For example, according to one embodiment, a Web interface may be used to enter the identifiers manually and/or to select the identifiers from an existing address book or contacts list and/or to submit the list to the system. According to another embodiment, a mobile device interface (e.g., on a cell phone or PDA) may be employed to enter the identifiers manually and/or to select the identifiers from a contacts list and/or to communicate the list to the system. According to still other embodiments, virtually any type of messaging interface, e.g., instant messaging, text messaging (e.g., SMS), email, etc., and associated contacts lists or address books may be used to identify participant identifiers and/or submit them to the system (e.g., using the specific message type employed by that interface).

In another example, a user of any integrated office contact application (e.g., Microsoft Outlook) could use that interface to set up a list of participant identifiers (and even initiate a conference call) according to the present invention. For example, the call originator could identify some number of contacts in the Outlook interface, e.g., using the “invite” functionality, which would result in the associated contact numbers being queued up as described herein and the conference call either being initiated for the queued up numbers or scheduled for initiation at some later time.

Virtually any type of contacts list, address book, or combination of such sources may be used for creation of such a list. And as will be understood, such functionality could be implemented in a wide variety of ways including, for example, in a Web page, in a stand-alone application, in a browser or search engine tool bar, in work collaboration software, etc.

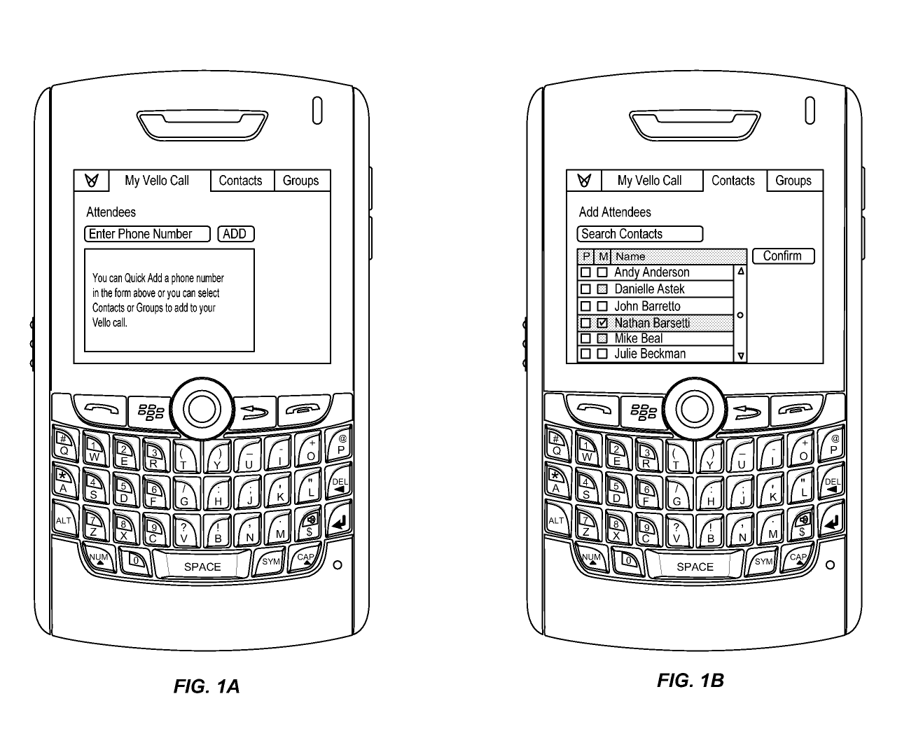

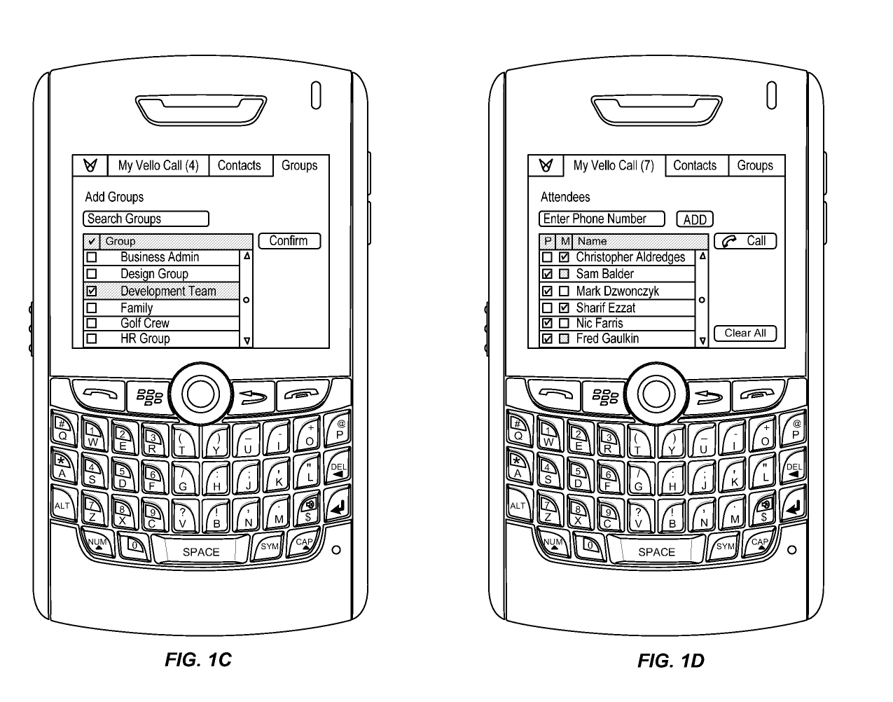

FIGS. 1A-1D illustrate examples of mobile Web interfaces by which a list of conference participants may be generated on a particular type of mobile device, i.e., a BlackBerry®. It should be noted that this is only one example of a mobile device which may be used with embodiments of the present invention. Selection of the “My Vello Call” tab results in presentation of an interface in which phone numbers may be manually entered (FIG. 1A). Selection of the “Contacts” tab results in presentation of an interface in which the user may search for and select individual contacts for inclusion in the conference (FIG. 1B). Selection of the “Groups” tab results in presentation of an interface in which the user may search for and select previously created groups for inclusion in the conference (FIG. 1C). After conference participants are identified, selection of the “My Vello Call” tab results in presentation of an interface in which the participants are identified, and from which the conference may be initiated by selecting the “Call” button (FIG. 1D).

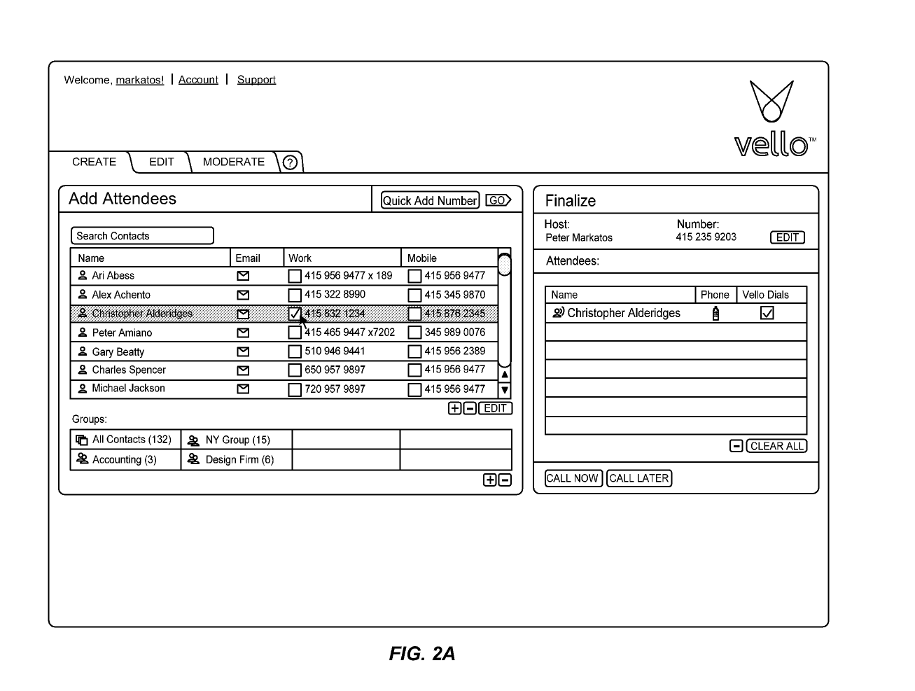

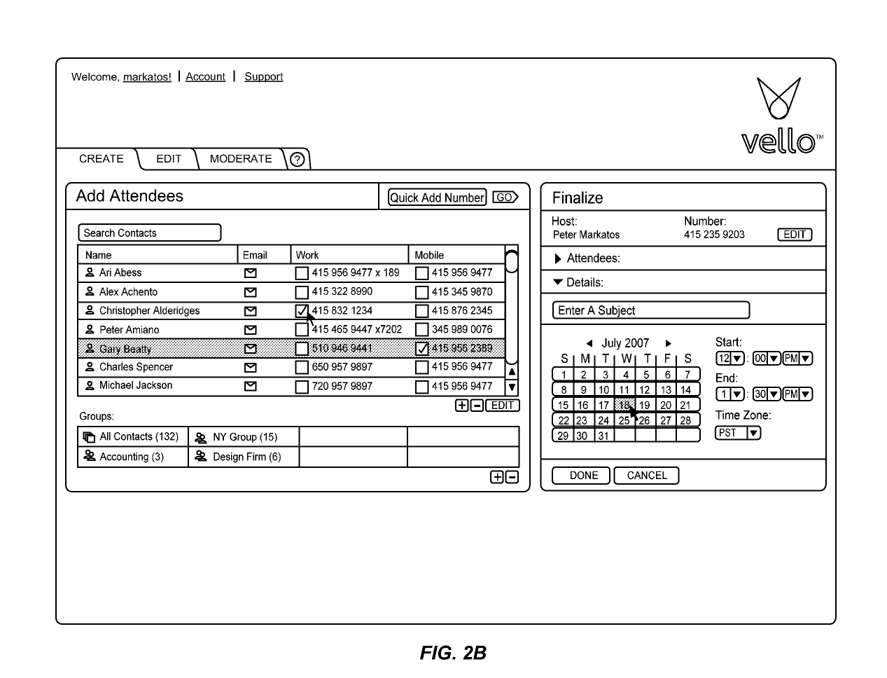

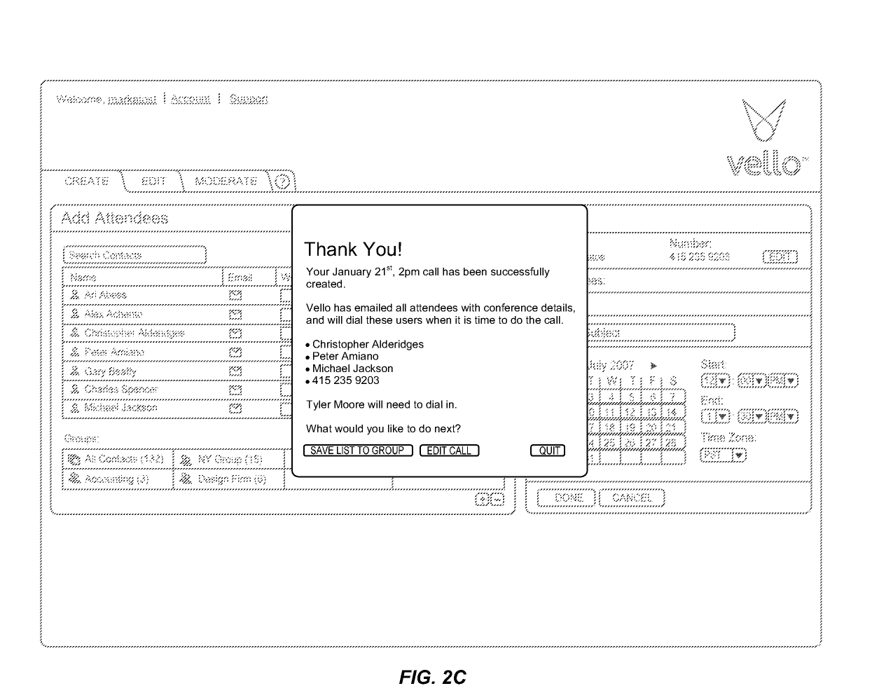

FIGS. 2A-2C illustrate examples of Web interfaces by which a list of conference participants may be generated on a personal computer. Selection of the “Create” tab results in presentation of an interface in which phone numbers may be manually entered, individual contacts may be searched and selected, and previously created groups may be searched and selected for inclusion in the conference (FIG. 2A). Selection of the “CALL NOW” button results in initiation of the conference. Selection of the “CALL LATER” button results in presentation of an interface in which a date and time for initiation of the conference may be selected (FIG. 2B). Selection of the “Done” button results in presentation of an interface acknowledging successful scheduling of the conference as well as providing some additional functionalities, e.g., saving the current list as a group, editing the call, etc. (FIG. 2C).

Once created, a list may be stored (e.g., in the user's contacts list or address book) for later use. In addition, users may create lists of lists, i.e., they may select previously created lists as an entry in a new list which would result in the system calling out to each member of each list identified in the new list.

According to a specific embodiment, the identifiers in a list may be entered sequentially and separated by any type of delimiter, e.g., an ampersand, a space, **, ##, semicolon, enter key, etc. The number of identifiers in the list is limited only be the limits of the underlying conferencing bridge with regard to the number of participant calls that can be mixed.

According to a particular embodiment, each list is associated with a particular phone number, e.g., a toll free number, which the originator may call and which results in the originator being placed in the conference and the conference system calling out to all of the participants on the list associated with that number. According to one approach, the originator may be placed into the conference as part of his initial connection to the system. According to another approach, the originator's initial connection to the system is terminated and he is called back along with the other participants. This may be done in a manner which is transparent to the originator, i.e., he would be unaware that the disconnection occurred.

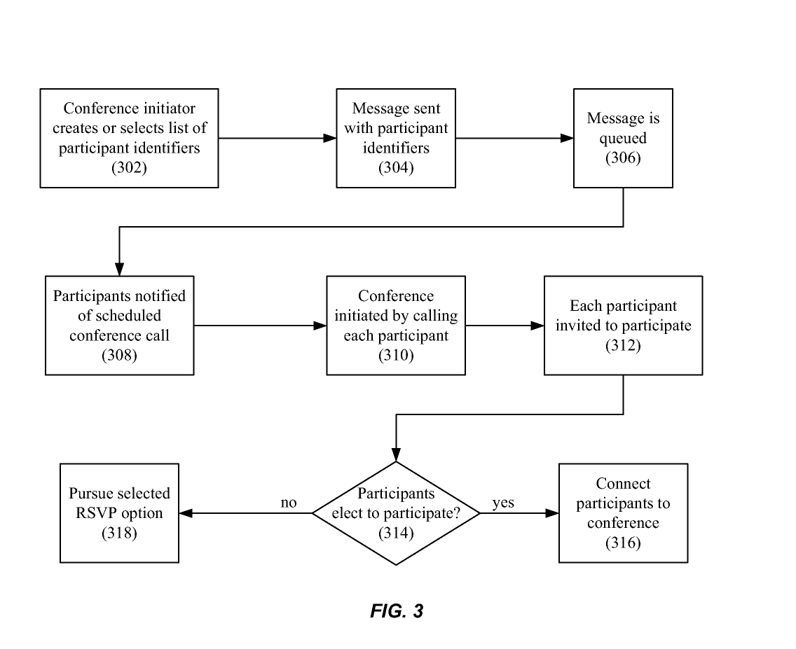

Operation of a representative implementation will now be described with reference to the flowchart of FIG. 3. To initiate a conference, the conference call originator generates a list of participant identifiers (302), e.g., he identifies participant identifiers using any of the techniques described above, or other suitable techniques. According to various embodiments, the conference call originator may be any end user of the conferencing services enabled by the present invention. It should also be noted that the call originator may be one of the participants of the conference call, or may set up the call for a set of participants in which he is not included.

Once the list is generated, a message is sent to the Vello server which includes a string of participant identifiers, i.e., corresponding to the list (304). The string may include only the information required to contact the participant, e.g., the phone number. However, embodiments are contemplated in which other information is also included such as, for example, the participant's name, other contact information (e.g., alternate phone number or email address), etc. It should be noted that “the message” may be a series of messages or transmissions which provide the information to the system which is necessary for initiation and/or scheduling of a conference call.

It should also be noted that the message to the Vello server may be sent from a wide variety of device types, over a wide variety of media, and using virtually any communication protocol. For example, the message may be sent from a Web interface (e.g., on a personal computer, PDA, cell phone, etc.). Alternatively, the message may be sent using a text message (e.g., SMS from a mobile device, or an instant message from a personal computer). As yet another alternative, the message may be sent using touch tones (e.g., DTMF) over a phone call. As a still further alternative and as discussed below, the message may be sent from a mobile phone, e.g., a cellular phone, which includes the functionality (e.g., integrated in the firmware, or in a downloaded application) which allows the conference call originator to enter or select identifiers and insert delimiters (e.g., using the keypad and/or soft keys), and send the message using the “Send” key.

As indicated above and according to some embodiments, initiation of the conference may begin in response to receipt of the message. Alternatively, and as implied with reference to FIG. 2B, the message may identify a later time at which the conference is to occur, thereby enabling the scheduling of a conference ahead of time. Such embodiments may also be used to achieve immediate initiation of the conference by identifying an imminent time (e.g., within seconds of message receipt). Some useful approaches which may be employed with various embodiments of the invention to effect the scheduling and initiating of conferences, messages, invitations, and reminders as described herein may be implemented, at least in part, according to techniques described in U.S. Pat. No. 7,177,404 and U.S. Patent Publication No. US-2007-0064883-A1, the entire disclosures of both of which are incorporated herein by reference.

Regardless of how the message is sent, once received, if the message includes a scheduled conference time, the message is queued by the Vello server (306) for conference initiation at the specified time. Otherwise the conference may be initiated immediately. According to some embodiments, the participants in the list are notified of the scheduled conference call (308).

Notifications and/or reminders of a scheduled conference may be accomplished in a variety of ways. For example, an automated phone call can be placed to each participant phone number at the time the conference is first set up, or at some predetermined time before the conference is actually initiated. In another example, text messages or emails may be generated to the participants which include the call particulars. Such an embodiment could be enabled, for example, where the system has access to additional contact information for the participants.

According to embodiments which involve notifications and/or reminders, each participant could be given options in the message for indicating things like availability or a different number at which the participant should be reached when the conference is initiated. The mode of providing this information could relate to the mode by which the notification was communicated. So, for example, if the participant is notified by email, a reply email could be used to provide a response. Alternatively, if the participant is notified by an automated message to his phone, a reply function such as that described in U.S. Patent Publication No. US-2007-0064883-A1 (incorporated herein by reference above) may be employed. The system can then use this information to take appropriate action, e.g., notify other participants, facilitate rescheduling of the conference, etc.

At the scheduled time, the Vello server initiates the conference by calling out to each participant identified in the stored list (310). This may or may not involve calling out to the call originator depending on the situation. For example, embodiments are contemplated in which the call originator is a participant in the conference call, but is connected to the conference call in some other manner. In addition, embodiments are contemplated in which the call originator is not a participant in the conference call.

According to some implementations, each participant is connected to the conference upon answering the call. According to other implementations, each participant is presented with an automated or recorded message inviting the participant to enter the conference (312). For example, such a message may provide multiple “RSVP” options from which the participant may select using the phone keypad, e.g., “Press 1 to enter the conference; press 2 to decline participation; press 3 to specify a call back time; press 4 to be called at a different number; etc.” If the invited participant elects to participate (314), he is connected to the conference (316), otherwise the selected alternative RSVP option is effected (318).

For example, if the invited participant selects an option like option 3 above, he may be prompted for a specific number of minutes the system should wait before calling again, or a specific time at which the system should call. If the invited participant is a “priority” participant, i.e., a participant without whom the conference cannot proceed, the entire conference may be held up until that participant is connected. This may involve placing the other participants on hold until the priority participant connects, or reinitiating the entire conference at some later time.

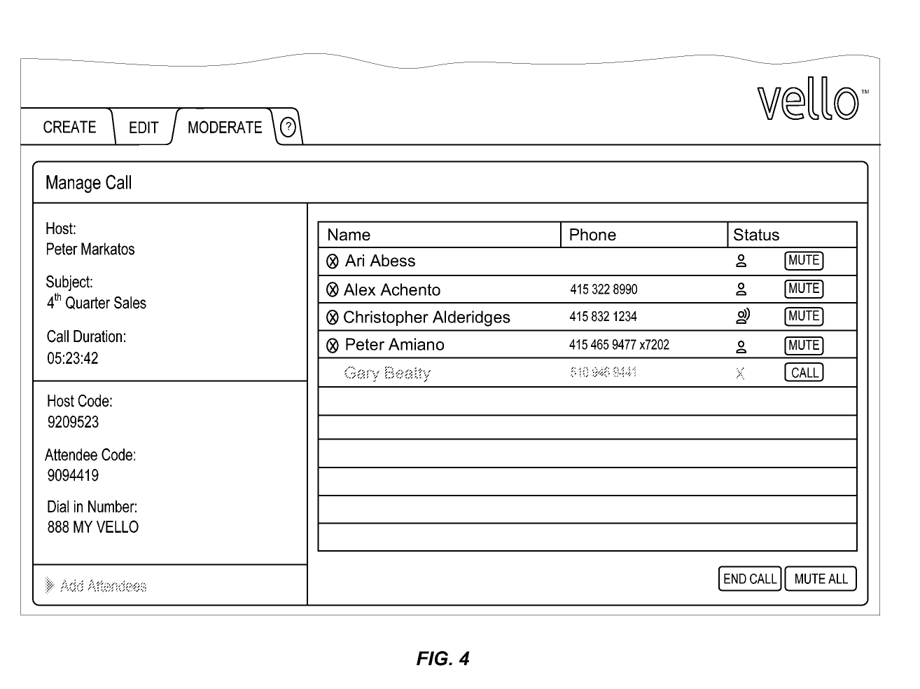

FIG. 4 illustrates an example of a dashboard interface with which a conference originator or moderator may manage and/or monitor the status of a conference. Each participant and his current connection status is identified. This may include both the name and the participant identifier (e.g., the phone number) of each. In addition, when a participant is speaking, the entry corresponding to that participant may be highlighted in some way. Controls may also be provided by which all or only some of the participants may be muted. In addition, the moderator is enabled to add attendees during the conference. This may be done by specifying a participant identifier by which the system will then contact the additional participant. This contact could be in a manner similar to the originally identified participants. Alternatively, a message could be sent to the additional participant which instructs him how to join the conference by conventional means. Similar dashboards with at least some of these functionalities might also be made available to other participants in the conference.

According to some embodiments, the participants identified in the list associated with a scheduled conference are enabled to call into the conference bridge to be connected to a conference. This functionality is useful in cases where, for example, a participant is not available to receive the initial call when the conference begins. That is, if the participant cannot take the call at the scheduled time, he can still participate in the conference by calling in to a number which may be provided, for example, in a voice mail message left when he did not answer the initial call. The call-in number may be unique to the specific conference to allow the system to recognize to which conference the caller is trying to connect. And because the Vello server already has the participant's phone number as part of the participant list, the phone number of the late incoming call (e.g., as identified by Caller ID) may be matched to the stored number to facilitate entry into the conference. In some implementations, identification of the caller's number may alone be sufficient to identify the correct conference.

On the other hand, if a late participant is not calling from the phone identified in the list, he may be prompted for a code or identifier (e.g., his stored number, an access code provided with the call-in number, etc.) to get into the conference. Similarly, if a participant has not been identified in the list, he may nevertheless be given access to the conference in a conventional manner.

According to a particular set of embodiments, various functionalities described herein may be leveraged to enable creation of an “on demand” conference room for a specific set of participants. That is, for example, the list of participants may be stored such that if any of the identified participants (or a particular one of the participants) calls into the system (e.g., as identified by Caller ID), a conference is initiated in which any or all of the participants identified in the list may participate. That is, the system treats a call in to the system from one of the numbers in such a list as an event which precipitates initiation of a conference.

The list for such an “on demand” conference may be stored indefinitely (e.g., until canceled), or for set periods of time (e.g., a month or a year). This allows one-time creation of and easy connection to a conference at any time without having to create and schedule each connection event ahead of time. Thus, the “on demand” nature of some conventional conferencing solutions is provided without the necessity of requiring an access code or password from the listed participants to connect to the conference. And as described above, additional participants not identified in the stored list may also connect to the conference and participate in a conventional manner, e.g., with the appropriate phone number and access code.

Embodiments are also contemplated in which the system can handle calling out to phone systems which have extensions. That is, for example, when a participant identifier is a phone number with an extension, the system may be configured to recognize when the main number is answered and then dial the extension. Alternatively, the system can simply insert a sufficient time delay before dialing the extension to ensure that the main line is answered.

Specific embodiments of the invention will now be described with reference to a particular type of phone (also referred to herein as the “Ampersand Phone”) which is specially configured to take advantage of various aspects of the present invention. As will become apparent, various of the functionalities described above may be included in the Ampersand Phone. According to one class of embodiments, a simple mechanism is enabled or provided on the phone, e.g., an “&” control, which enables the user to queue up the participant identifiers in a manner which may be analogized to the way in which email addresses separated by commas can all be recipients of a single email. The participant identifiers may already exist in, for example, the user's address book, or may be entered manually at the time the conference is being set up. The phone is configured such that by selecting the “&” control, the phone enters a conference mode in which a variety of different functionalities may be enabled for its various input mechanisms. For example, because the phone is in conference mode, the “Send” may be used to initiate a conference as described herein rather than to initiate a conventional call.

It should be noted that although embodiments are described herein with reference to an “&” or “ampersand” control, the mechanism which enables the queuing of contact numbers may be implemented in a wide variety of ways without departing from the scope of the invention. For example, a new key may be provided on phones for this function. Alternatively, existing keys on phones can be utilized. As yet another alternative, multiple keystroke combinations could be employed to effect this functionality. The “&” or “ampersand” control could be embodied in a hard key, a soft key, touch screen key, etc. If the interface is a computer screen, entering the number and hitting the “Enter” key could facilitate such queuing. Virtually any mechanism associated with an interface which facilitates entry or selection may be employed for this purpose.

According to a specific embodiment, the Ampersand Phone is a mobile or IP-based phone with the addition of an ampersand “&” key. As mentioned above, this key may be a hard key that is built into the telephone handset or it can be a soft key or otherwise part of a graphical user interface. Ampersand keys can be used on all forms of telephone handsets, e.g., traditional landlines, cell phones, IP phones, etc. and made available on screen-based phones with custom software downloads as well as a softphone, software, or Web-based implementations.

According to specific embodiments, the Ampersand Phone supports two distinct conference-related modes: Group Calling and Broadcast. Each mode supports immediate and scheduled sub-modes allowing for Group Calls, i.e., conferences, or Broadcasts to be scheduled for future delivery.

Ampersand Phone users will benefit from an expanded feature set through a variety of handset and/or Web-based functionalities which complement existing handset functionality. These functionalities may include, but are not limited to: Web-based or desktop-based support applications; online list creation with an import feature; automatic syncing; third party scheduling; expanded broadcast capabilities, e.g., text-to-speech with multiple voices/languages; expanded reply capabilities, e.g., DTMF surveys, or voice libraries; pending group call and broadcast lists; and history tracking.

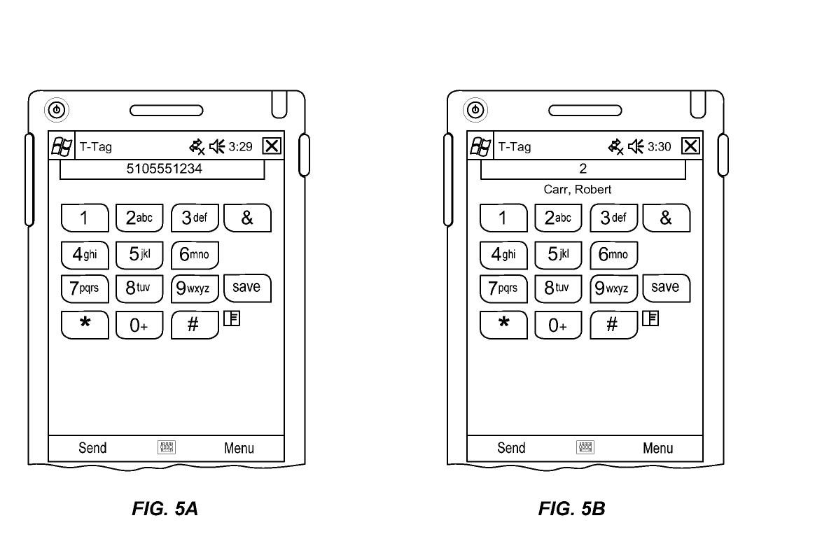

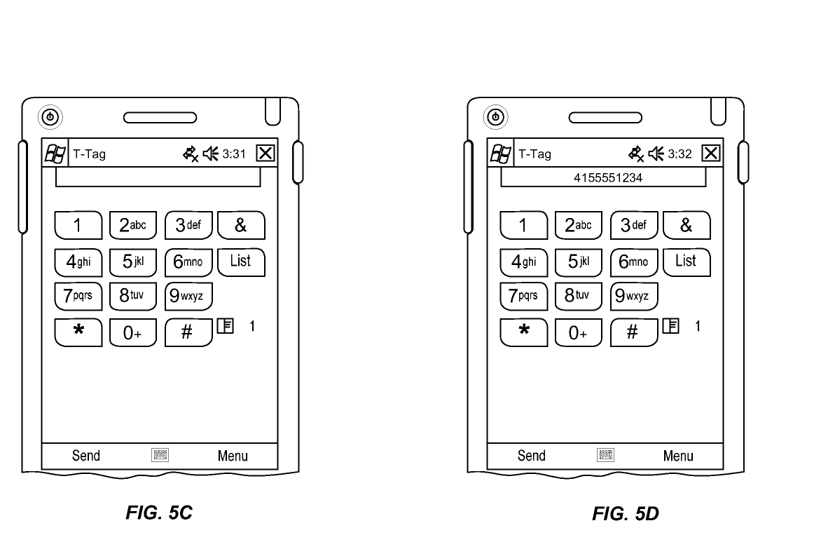

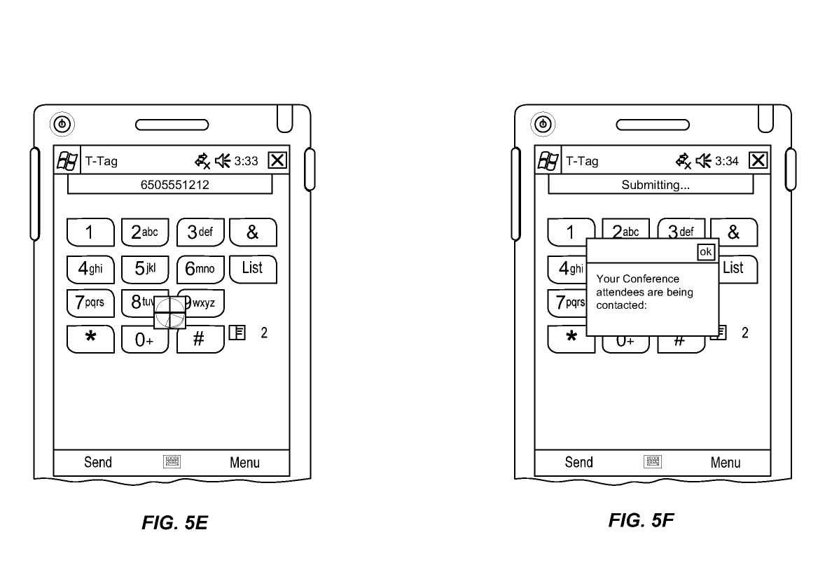

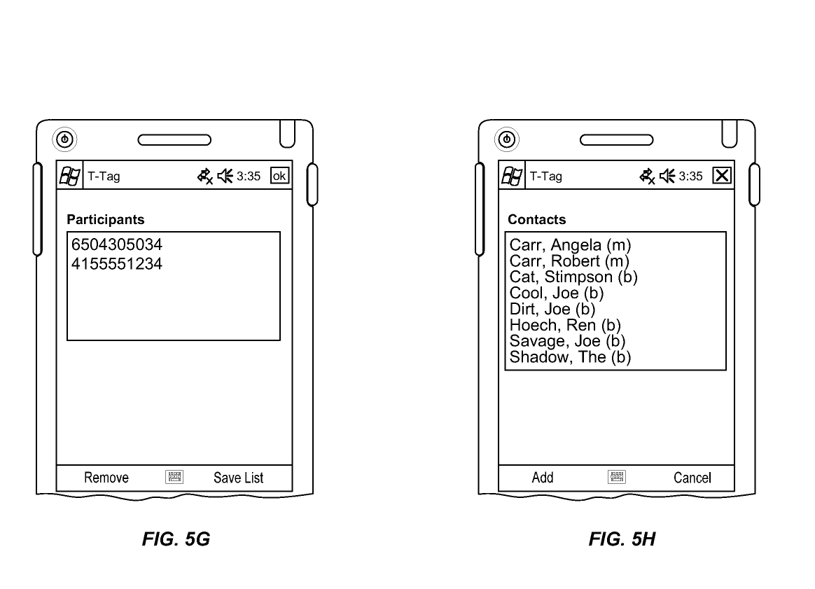

Operation in the Group Calling mode to initiate a conference with the Ampersand Phone will now be described with reference to FIGS. 5A-5H. As described above, initiation of a conference can be immediate or scheduled for a later time. To initiate an immediate conference, the user may queue a phone number in a variety of ways including, for example, by directly entering the phone number, e.g. “510-555-1234” as shown in FIG. 5A, by entering a code from the user's personal phone book or directory, e.g. “2” as shown in FIG. 5B, or by selecting the contact name directly, e.g., “Home,” from a contact list. This may also involve selection of the mode or type of device if the participant has multiple contact modes.

When the ampersand key, i.e., the “&” key, is pressed and as shown in FIG. 5C, a “1” appears in the interface to indicate that one number or participant identifier has been added to the queue, and a “List” button appears which allows the user to view the participant identifiers currently in the list. The user may then queue another phone number, e.g. “415-555-1234” as shown in FIG. 5D. Phone numbers may also be queued by selecting the person directly from the user's phone book and adding them to the list. See for example, FIG. 5H.

The user continues queuing phone numbers, separated or delimited by the & key until he has entered all of the numbers he wishes to be in on the conference. When the last phone number is entered, the user initiates the conference by, for example, pressing the “Send” key as illustrated in FIG. 5E. As will be understood, reference to the “Send” key relates to embodiments involving cellular phones and the like and is merely used as an example. For other implementations involving different types of voice terminals, an equivalent mechanism may be used. For example, in the case of softphones, an equivalent mechanism might be a “Connect” or “Call” button.

The message to initiate the conference call is sent to the Vello server for immediate delivery. All of the phone numbers in the participant identifier list are then simultaneously called as illustrated in FIG. 5F. At any time, the user may see the list of participants in the conference by pressing the ‘List’ button as illustrated in FIG. 5G.

After queuing the participant(s) and instead of initiating the conference, the user may select a “Schedule” option which may appear on the screen as soon as an individual phone number or list is queued. In response to selecting this option, the user will be queried for the date and time for the conference. Contact time may be defined by the time on the user's Ampersand Phone.

As mentioned above, the user may also be provided with the option of announcing the conference in advance to the participants as well as reminding participants of the impending call. According to some embodiments, announcements and reminders are delivered as scheduled broadcasts to the participants. If the user selects standard announcements and reminders, an immediate broadcast is sent to all participants to announce the conference: “[User] has scheduled a conference for your participation on [Day] at [Time]. In addition, at some set time, e.g., an hour, before the conference time a Broadcast may be sent to all participants to remind them of the conference: “[User] wants to remind you that your conference will take place at [time] today, an hour from now.”

Conference announcements and reminders can be customized with the user's own text or in the user's own voice. Times of announcement and reminder delivery and frequency of reminders can also be customized. Announcements and reminders may include a standard invitation for the participant to replay it. Announcements may offer the participant the opportunity to reply. This allows the participant the opportunity to reschedule if the proposed time is inconvenient. Some suitable techniques for accomplishing these functionalities are described in U.S. Pat. No. 7,177,404 and U.S. Patent Publication No. US-2007-0064883-A1, incorporated herein by reference above.

A broadcast message can be immediate or scheduled for later delivery. For an immediate broadcast message, after queuing a list (or even a single phone number), the user has the option to send a broadcast message to the participant(s) instead of engaging in a conference by selecting a “Broadcast” option which appears on the screen as soon as an individual phone number or list is queued.

Having selected the broadcast option, the user may initiate the broadcast message by hitting, for example, the “Send” key. The system then prompts the user to record a message. The user can hear his recording and accept it when satisfied using, for example, standard voicemail protocols. After the broadcast message is played, the participant will have the option to replay the message: “To hear this message again, press 2.” The user can also select the reply option which offers the participant the possibility of replying to the broadcast message. If reply is selected, after the message is played, the participant is prompted: “To reply to this message, press 3.” The participant is then prompted to record a message. The participant can hear his recording and accept it when satisfied according to standard voicemail protocols.

The system then calls the user, and the reply message is played: “This is a reply from [participant's phone number]. Press 1 to hear it.” If 1 is pressed, the system will play the participant's recorded message, with options to replay and/or reply. According to one implementation, if the system detects that it is dealing with an answering machine, the options to reply and replay may be omitted.

After queuing the participant(s) and instead of initiating an immediate broadcast, the user may select the “Schedule” option which appears on the screen as soon as an individual phone number or list is queued. In response to selecting the schedule option, the user will be queried for the date and time for the broadcast. Again, contact time may be defined by the time on the user's Ampersand Phone.

According to some embodiments, in the Ampersand Phone, standard phone functionality is enhanced to allow the storage of conference participant lists generated in accordance with the invention. For example, an Ampersand Phone with 100 storage slots available would be able to store single entries or lists in any slot. Queuing a new individual number causes the user to be prompted to save the number. The name and other information can be stored for the number, as in standard usage. Once the ampersand key has been pressed, the user will have the option of saving the list. Future calls to the list can be accomplished by queuing its location in the directory (e.g. “86”) and pressing ‘Send.’ This maintains the functionality already present for individual calls on standard phones.

As mentioned herein and according to some embodiments, users have the option of announcing the conference and inviting the participant(s) to participate. Alternatively, all of the participant's phones may be called and connected immediately to the conference once answered.

An announcement message may come in different forms, e.g., a standard message: “This is a conference initiated by [user's name]. Press 1 to join it;” or a custom message that may be used for calls on a one-off, global, or directory-list-specific basis (i.e., a specific message for a specific group). Message preferences may be included as part of the information saved in the directory for lists. In a broadcast, the standard message could be: “[User] is sending you a telephone broadcast. Press 1 to hear it”.

Custom messages are recorded by the system after the user presses the ‘Send’ button. The user can hear his/her recording and accept it when satisfied according to standard voicemail protocols. Once accepted by the user, the call may go through as directed. A previously recorded custom message id, e.g., stored with the directory list entry, may be sent automatically when the user presses the ‘Send’ button. The actual audio may be stored centrally in the system.

The use of an announcement message may be characterized by any of several advantages. For example, the participant receiving the message has the option to decline participation. In addition, if a participant is unavailable, the other participants are not necessarily held up or forced to listen to an answering machine.

As discussed above, a participant who misses the initial call to join a conference can still join the conference later if, for example, he receives a message the system leaves in his voice mail. That is, if the system determines that it is are interacting with a voice mail system, a specific message may be left for the participant such as, for example, “[User] invited you to join a conference on [date and time]. If you wish to join the conference, please dial 1-888-888-TTAG. You will automatically join the conference if it is still in progress.” The system will recognize the participant's phone number when the participant calls the number provided and immediately connect the participant to the conference if it is still ongoing. If the conference is finished, the participant may be so informed.

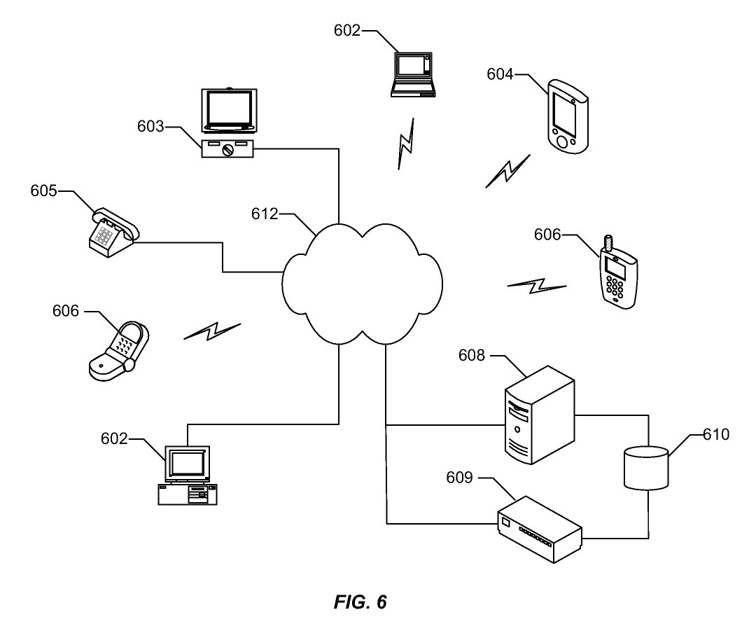

As described above, embodiments of the present invention facilitate the setting up, scheduling, initiating, and handling of conferences using any of a wide variety communication devices, services, and applications in any of a wide variety of computing and telephony contexts. For example, as illustrated in FIG. 6, implementations are contemplated in which conference participants set up, schedule, and participate in conferences via any type of computer (e.g., desktop, laptop, workstation, tablet, etc.) 602, media computing platforms 603 (e.g., cable and satellite set top boxes), handheld computing devices (e.g., PDAs, etc.) 604, land lines 605, cell phones 606, or any other type of computing or communication platform.

The logic (e.g., as embodied in computer code or instructions) which controls at least some of the various functionalities associated with setting up, scheduling, and initiating conferences may be resident on such devices, e.g., as part of a browser or other application, be served up from a remote site, e.g., in standard or mobile Web pages, or some combination of both. The facilitation of conferences (e.g., calling out to participants, connecting participants to conferences, mixing voice communications from different types of devices, services, and application, etc.) is typically accomplished on one or more platforms (represented by server 608 (e.g., the Vello server), conference bridge 609, and data store 610) remote from end user devices. It will be understood that each of these may represent multiple platforms working in parallel. The invention may also be practiced in and across a wide variety of network environments (represented by network 612) including, for example, the PSTN, telecommunications networks, wireless networks, TCP/IP-based networks, LANs, WANs, cable networks, etc., and various combinations of any of these.

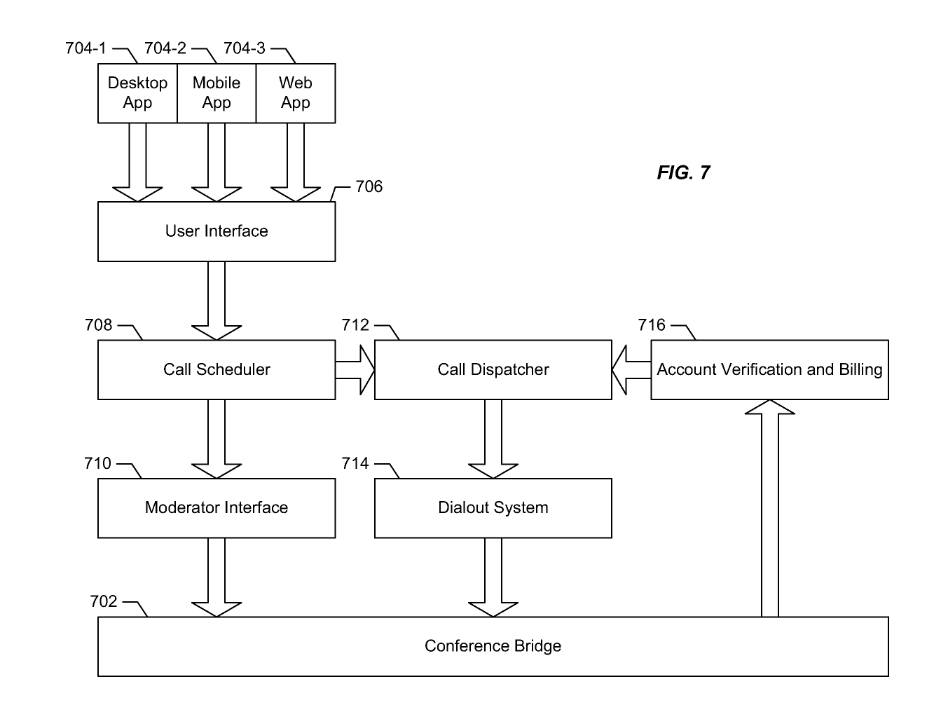

A simplified block diagram of various system components in an example of a conferencing system 700 designed in accordance with a specific embodiment of the invention is shown in FIG. 7. The depicted implementation layers various of the functionalities described herein on a conference bridge 702. As described above, conference bridge 702 may be, for example, a conventional conference bridge available from any of a wide range of suppliers of audio conferencing equipment.

Various applications 704 intended to enable interaction with the system via different types of devices interact with a user interface component 706 which, in turn, interacts with a call scheduler component 708 to facilitate the set up and initiation of conference calls. In the embodiment shown, call scheduler 708 interacts with conference bridge 702 via moderator interface 710 which may enable a call originator or moderator to have increased visibility and/or control over the conference. Call scheduler 708 also interacts with call dispatcher 712 which, in turn, interacts with conference bridge 702 via dial out system 714 to enable connection to the voice communication devices associated with the various participants as described herein. Conference bridge 702 interacts with call dispatcher 712 via account verification and billing component 716.

In addition, the computer program instructions with which the various functionalities of various embodiments of the invention are implemented (e.g., as embodied by the system components shown in FIG. 7) may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention have been described herein using the terms “phone” and “phone number” as short hand for a much broader range of communication devices, services, and applications, and the associated identifiers for facilitating connections to other devices, services, and applications. One of the advantages of particular embodiments of the invention is that they can facilitate participation in a single conference via many different device types, services, and applications. That is, specific embodiments of the invention enable conference participation via virtually any telephony or voice communication device or application anywhere in the world. This includes land lines, all manner of mobile phones (e.g., wireless, cellular, satellite, etc.), as well as voice-over-IP (VoIP) phones and clients, and any of a wide variety of Internet-based voice and telephony applications (e.g., Skype). This is to be contrasted with conventional conferencing solutions which are limited in terms of the device types or applications supported. Therefore, references herein to phone and phone number should not be considered as limiting the scope of the invention.

Another advantage of specific embodiments of the present invention is that they are not dependent on any particular voice communication service provider. That is, all that is needed is some mechanism to queue up participant identifiers (or to identify such a list) and contact the back end system. None of the participants need anything other than a voice communication device with a contact number; virtually any type of voice communication device will do. Moreover, as mentioned above, setting up a conference call according to the present invention does not require that a person having administrative privileges to a conference bridge program a set of phone numbers into the bridge. Rather, any end user may readily create an ad hoc list of participants and initiate or schedule a conference via a wide variety of channels.

It should also be noted that, with some embodiments, all calls may be treated as conference calls. That is, if a caller is calling only one other person, the same techniques described herein may be employed to arrange a two-party conference call which, to the participants involved, is very similar to a conventional two-party phone call. Thus, the scope of the present invention should not be construed to exclude two-party conference calls.

Moreover, layering functionality enabled by embodiments of the present invention over a conventional conference bridge is only an example of a suitable implementation. Embodiments are contemplated in which some or all of the functionalities described herein may be directly integrated into a conference bridge or an equivalent system without departing from the scope of the invention.

Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for initiating a conference call having a plurality of participants, the method comprising:
enabling a call originator to identify one or more participant identifiers;
enabling the call originator to establish a first connection to a remote system by which the one or more participant identifiers are communicated to the remote system, establishment of the first connection not requiring administrative access to the remote system; and
establishing a second connection from the remote system to each of one or more voice communication devices corresponding to one or more of the participants using the one or more participant identifiers.

2. The method of claim 1 further comprising transmitting an automated message regarding the conference call to each of the one or more voice communication devices via the corresponding second connection, the automated message enabling a plurality of options relating to the conference call, one of the options being connecting to the conference call.

3. The method of claim 2 wherein the plurality of options includes one or more of declining participation in the conference call, specifying a call back time, or specifying a different number at which to be called back.

4. The method of claim 1 wherein each participant is connected to the conference call upon establishment of the second connection to the corresponding voice communication device.

5. The method of claim 1 further comprising connecting the call originator to the conference call via either of the first connection, or one of the one or more second connections.

6. The method of claim 1 wherein the one or more voice communication devices include one or more of a wireless phone, a cellular phone, a satellite phone, a landline phone, a personal digital assistant, a personal computer, messaging software, or telephony software.

7. The method of claim 1 wherein the one or more participant identifiers is identified and the first connection to the remote system is established via one of a Web interface, a mobile device interface, a messaging interface, or a contacts interface.

8. The method of claim 1 further comprising enabling the call originator to specify a time at which the conference call is to be initiated, and wherein the establishment of the one or more second connections is initiated at the specified time.

9. The method of claim 8 further comprising notifying each participant about the specified time of the conference call prior to the specified time.

10. The method of claim 1 further comprising, subsequent to initiation of and during the conference call, receiving a connection request from a first voice communication device having a first identifier associated therewith for facilitating connection to the first voice communication device, and automatically connecting the first voice communication device to the conference call without requiring further authentication where the first identifier is included among the one or more participant identifiers.

11. The method of claim 10 further comprising requiring authentication before connecting the first voice communication device to the conference call where the first identifier is not included among the one or more participant identifiers.

12. A system for initiating a conference call having a plurality of participants, the system comprising at least one computing device configured to:
enable a call originator to establish a first connection to a remote system by which one or more participant identifiers are communicated to the remote system, establishment of the first connection not requiring administrative access to the remote system; and
establish a second connection from the remote system to each of one or more voice communication devices corresponding to one or more of the participants using the one or more participant identifiers.

13. A voice communication device, comprising a user interface controlled by first logic configured to enable a call originator to identify one or more participant identifiers, each of the participant identifiers corresponding to an additional voice communication device and enabling connection to the additional voice communication device, the user interface being further controlled by second logic configured to enable the call originator to initiate establishment of a connection to a remote system by which the one or more participant identifiers are communicated to the remote system, thereby enabling the remote system to initiate a conference call including the voice communication device and the one or more additional voice communication devices, wherein establishment of the connection does not require administrative access to the remote system.

14. The voice communication device of claim 13 wherein the user interface is further controlled by third logic configured to enable the call originator to specify a time at which the conference call is to be initiated.

15. The voice communication device of claim 13 wherein the voice communication device comprises one of a wireless phone, a cellular phone, a satellite phone, a landline phone, a personal digital assistant, a personal computer, messaging software, or telephony software.

16. The voice communication device of claim 13 wherein the first logic is configured to enable the call originator to separate the one or more participant identifiers arranged in a string with one or more delimiters using a control associated with the interface.

17. A computer-implemented method for facilitating a conference call having a plurality of participants, the method comprising:
storing a plurality of participant identifiers associated with the conference call;
receiving a first connection request from a first voice communication device having a first identifier associated therewith for facilitating connection to the first voice communication device; and
automatically connecting the first voice communication device to the conference call without requiring further authentication where the first identifier is included among the plurality of participant identifiers.

18. The method of claim 17 further comprising initiating the conference call in response to the first connection request where the associated identifier is included among the plurality of participant identifiers.

19. The method of claim 17 further comprising requiring authentication before connecting the first voice communication device to the conference call where the first identifier is not included among the plurality of participant identifiers.

20. The method of claim 17 wherein the first connection request from the first voice communication device is established using a call-in number, the method further comprising identifying the conference with reference to the call-in number.

21. The method of claim 17 further comprising identifying the conference with reference to the first identifier.

22. A system for initiating a conference call having a plurality of participants, the system comprising at least one computing device configured to:
store a plurality of participant identifiers associated with the conference call;
receive a first connection request from a first voice communication device having a first identifier associated therewith for facilitating connection to the first voice communication device; and
automatically connect the first voice communication device to the conference call without requiring further authentication where the first identifier is included among the plurality of participant identifiers.
